(19) United States
(12) Patent Application Publication
(10) Pub. No.: US 2010/0222022 A1
(43) Pub. Date: Sep. 2, 2010

(54) COMMUNICATION METHOD, COMMUNICATION SYSTEM AND ACCESS METHOD TO SERVICE PROVIDER BASE

(75) Inventors: Nozomi FUJITA, Kawasaki (JP); Naoki HARAGUCHI, Kawasaki (JP); Kenya NISHIKI, Chigasaki (JP); Kansuke KUROYANAGI, Yokohama (JP); Yukiko TAKEDA, Higashimurayama (JP)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/632,275

(22) Filed: Dec. 7, 2009

(30) Foreign Application Priority Data
Mar. 2, 2009 (JP) 2009-047504

(51) Int. Cl. H04W 4/26; H04W 12/00

(52) U.S. Cl. 455/406; 455/411

(57) ABSTRACT

A communication method, a communication system and a method of accessing a service provider base are disclosed. A network function gateway server of a communication common carrier includes a unit for executing at least one of the network functions based on the request sent from an xSP server and sending a network function execution response to the xSP server, and a unit for charging the subscriber corresponding to the service provider xSP in accordance with the number of times the network is used.

### INCORPORATION BY REFERENCE

The present application claims priority from Japanese application JP2009-047504 filed on Mar. 2, 2009, the content of which is hereby incorporated by reference into this application.

### BACKGROUND OF THE INVENTION

This invention relates to a service provider base for providing a third-party service provider with the network functions provided by a communication common carrier to general subscribers, or in particular, to an access method for permitting a service provider to use the network functions easily and execute the charge/settlement process positively through an authentication means equivalent to the one for general subscribers without a third-party management system of the communication common carrier.

In recent years, communication common carriers have begun to supply the content provider and the service provider (hereinafter referred to collectively as the service provider) with the network functions thus far supplied to general subscribers and thereby receive a consideration as a new income source. The service provider base, which is based on the concept of the service-oriented architecture, is intended to modularize the network functions including the telephone call, the message transmission and the acquisition of the position information and combine the function modules freely to be provided as a service.

The method of accessing the service provider base is being standardized by “The Parlay Group” joined by the communication common carriers and the communication equipment vendors throughout the world. The Parlay X technical specification formed on the basis of the Web service to permit even a developer not informed of the telephone mechanism to develop an application for easy operation of the telephone system is described in “Draft ETSI ES 202 504 (2007-June), Open Service Access (OSA), Parlay X Web Services”. The service provider base is required to appropriately control the accesses to the services made available to third parties. A technique for authenticating and granting the request from a third party and protecting the system against unauthorized accesses is described in JP-A-2007-89199. The third-party access gateway described in JP-A-2007-89199 has a function handler for receiving the service requests from third parties. The function handler extracts a safe certificate identifier from each service request, and by searching a profiling data base, can grant a third-party application related to the certificate identifier.

### SUMMARY OF THE INVENTION

The technique described in JP-A-2007-89199 presupposes that a service provider (defined to include a content provider) desirous of using a network function signs a service use contract with a communication common carrier and is granted the access to the network function. This poses the problem of a large overhead caused by the paperwork such as the preliminary examination and the charge settlement.

Also, the authentication/charge interface is varied from one communication common carrier to another, thereby posing the problem that a large cost is imposed on the part of the service provider to develop plural interfaces.

The technique described in “Draft ETSI ES 202 504 (2007-June), Open Service Access (OSA), Parlay X Web Services”, on the other hand, presupposes the access through the Web service and harbors the problem that a high program development cost limits the actual users.

This invention has been achieved in view of this situation, and a first object thereof is to provide a method in which the network functions can be utilized for positive authentication and charge process directly without advance registration using the authentication/charge functions which the mobile communication common carrier has for general subscribers.

A second object of the invention is to provide a method in which an application having built therein a program for using the network functions, or especially, a simple application called Widget is provided by the mobile communication common carrier to a third-party service provider (xSP) to permit the access to the network functions at a low development cost.

According to a first aspect of the invention, there is provided a communication method using a base server having plural network functions, a service provider sever for communicating with the base server and a subscriber information management data base, the method including the steps of:

the base server receiving a network function use request message from the service provider server;

the base server retrieving the subscriber information corresponding to the service provider server from the subscriber information management data base and authenticating the service provider server as a subscriber;

the base server generating the session information for the use of the network functions based on the authentication; and

the base server transmitting a message permitting the use of the network functions to the service provider server based on the session information.

According to another aspect of the invention, there is provided a communication system including a service provider server, a service user terminal, a service base server, a service subscriber information storage unit and a communication network,

wherein the service subscriber information storage unit stores the subscriber information for the services managed by the service base server,

wherein the service provider server reads the subscriber information from the service subscriber information storage unit and transmits it to the service base server, and

wherein the service base server includes an authentication processing unit for processing the authentication of the subscriber based on the subscriber information and a function control unit for controlling at least one of plural service functions based on the result of authentication by the authentication processing unit and transmitting the result of processing the service function to the service provider server.

According to still another aspect of the invention, there is provided a service provider base access method in which a third-party service provider server uses the service functions of other servers through a fixed communication network or an Internet, the method including the steps of:

the service provider base server distributing an application having built therein a command for transmitting a service function use request message to the user of the service of the service provider server;

the service provider server receiving and retransmitting the service function use request message transmitted by the operation of the application;

the service provider base server receiving the service function use request message from the service provider server;

the service provider base server transmitting a subscriber authentication request message to the service provider server;

the service provider base server receiving a subscriber authentication response message from the service provider server;

the service provider base server authenticating the service provider server as a subscriber by accessing the subscriber information for the service provider server in a subscriber information management data base and generating the session information to use the service function;

the service provider base server transmitting a service function use permission message to the service provider server;

the service provider base server executing at least one service function based on the service function use request received from the service provider server;

the service provider base server transmitting a response message containing the service function execution result to the service provider server; and the service provider base server recording the number of times the service function is used, and generating the charge information based on the number of times the service function is used.

According to this invention, the mobile communication common carrier can positively authenticate and charge the service provider xSP directly using the authentication and charge functions of the mobile communication common carrier for general subscribers without registration before use of the network function. As a result, a service permitting the service provider xSP to access the service provider base at low cost can be developed. Also, the communication common carrier can process the accesses from a multiplicity of service providers xSP at low cost. Further, the authentication using an xSIM card can improve the convenience of the user.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an example of the system configuration according to a first embodiment.

FIG. 2 is a diagram showing an example of the system configuration according to the first and second embodiments.

FIG. 3 is a diagram showing an example of the hardware configuration of a portable terminal according to the first and second embodiments.

FIG. 4 is a diagram showing an example of the hardware configuration of the xSIM card according to the first and second embodiments.

FIG. 5 is a diagram showing an example of the configuration of an xSP server having an interface for authenticating a service provider xSP in collaboration with the FMC technique according to the first embodiment.

FIG. 6 is a diagram showing an example of the configuration of the xSP server having an xSIM card interface for authenticating the service provider xSP according to the first embodiment.

FIG. 7 is a diagram showing an example of the hardware configuration of a server associated with the communication carrier service provider base according to the first and second embodiments.

FIG. 8 is a diagram showing an example of the function blocks of a third-party management server according to the first and second embodiments.

FIG. 9 is a diagram showing an example of the sequence of subscriber authentication according to the first embodiment.

FIG. 10 is a diagram showing an example of the functions blocks of the subscriber authentication server according to the first embodiment.

FIG. 11 is a diagram showing an example of the connection request IF processing flow for a subscriber authentication server according to the first embodiment.

FIG. 12 is a diagram showing an example of the subscriber information collation processing flow for the subscriber authentication server according to the first embodiment.

FIG. 13 is a diagram showing an example of the session information generation processing flow for the subscriber authentication server according to the first embodiment.

FIG. 14 is a diagram showing an example of the sequence for using a network function gateway server according to the first embodiment.

FIG. 15 is a diagram showing an example of the function blocks of the network function gateway server according to the first embodiment.

FIG. 16 is a diagram showing an example of the connection request IF processing flow for the network function gateway server according to the first embodiment.

FIG. 17 is a diagram showing an example of the access control processing flow for the network function gateway server according to the first embodiment.

FIG. 18 is a diagram showing an example of the SLA (service level agreement) maintenance control processing flow for the network function gateway server according to the first embodiment.

FIG. 19 is a diagram showing an example of the service use IF generation processing flow for the network function gateway server according to the first embodiment.

FIG. 20 is a diagram showing an example of the function blocks of a Widget distribution server according to the second embodiment.

FIG. 21 is a diagram showing an example of the processing sequence for Widget execution according to the second embodiment.

FIG. 22 is a diagram showing an example of a Widget execution screen according to the second embodiment.

FIG. 23 is a diagram showing an example of an enabler collaboration information management table according to the first embodiment.

FIG. 24 is a diagram showing an example of a charge master management table according to the first embodiment.

FIG. 25 is a diagram showing an example of a subscriber master information management table according to the first embodiment.

FIG. 26 is a diagram showing an example of a subscriber transaction management table according to the first embodiment.

FIG. 27 is a diagram showing an example of a filtering management table according to the first embodiment.

### DETAILED DESCRIPTION OF THE INVENTION

Examples of embodying the invention are explained below.

### First Embodiment

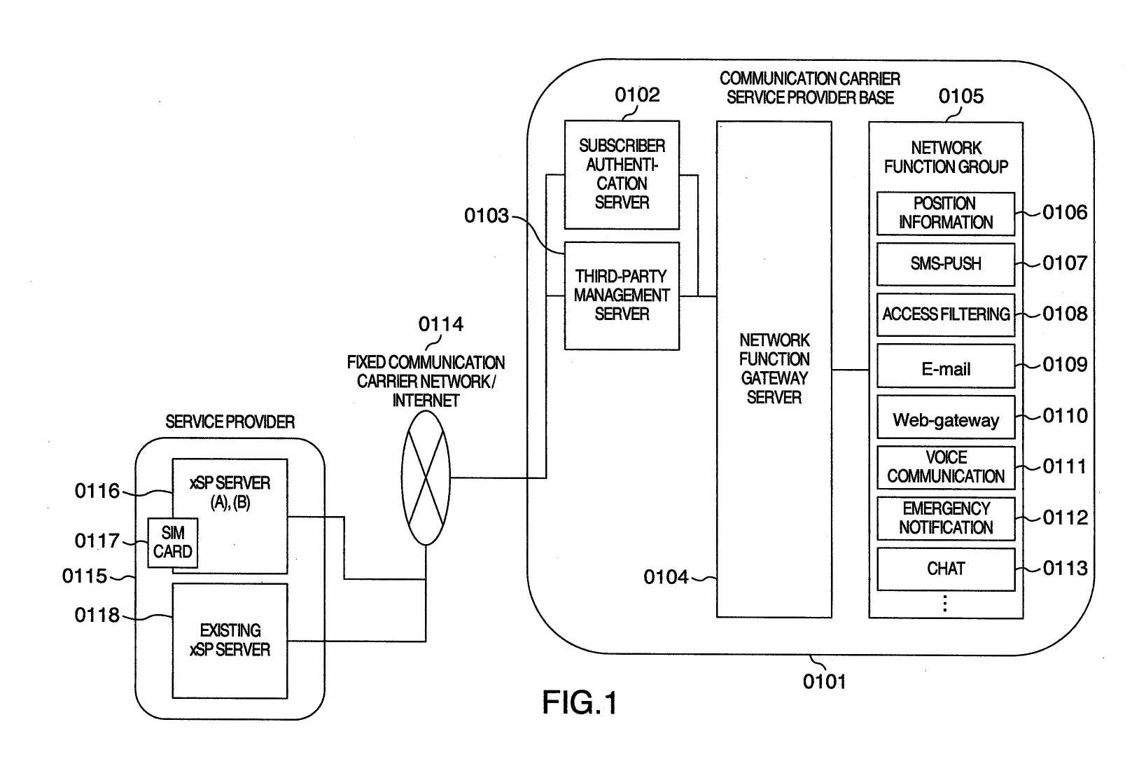

An embodiment of the invention is explained with reference to the accompanying drawings. FIG. 1 shows an example of the system configuration for a service provider xSP to use a communication carrier service provider base 0101 of the communication common carrier.

A service provider 0115 includes an existing xSP server 0118 managed by the conventional third-party management server 0103 and an xSP server (A) 0116 which includes an xSIM card (an IC card which stores the service subscriber information and can be used as a service subscriber information storage unit) 0117 or which can read the subscriber identification information in the xSIM card 0117 in collaboration with the FMC (fixed mobile convergence) technique. The network topology and the architecture for realizing the collaboration with the FMC technique is not limited to a specific package. This embodiment presupposes the direct connection by a portable terminal connector or the radio connection by Bluetooth, etc. In radio connection, the data held in the xSIM card 0205 is transferred between the radio communication interface 0303 of the second communication control unit (for collaboration with FMC) 0305 of the portable terminal 0204 and the radio communication interface 0502 of the first communication control unit (for collaboration with FMC) 0503 of the xSP server (A) 0116.

The xSP server (A), (B) 0116 and the existing xSP server 0118 are connected to the communication carrier service provider base 0101 through a fixed communication carrier network/internet 0114. The communication carrier service provider base 0101 may be configured as a server including the shown components as internal elements, or may refer to the whole configuration shown. The existing xSP server 0118, after being authenticated by the third-party management server 0103 of the communication carrier, accesses a network function group 0105 through a network function gateway server 0104 thereby to use the services. Each of the network functions is for controlling the service independently and managed independently of the xSP server (A), (B) 0116. In the process, the third-party management server 0103 takes charge of the charge information generation process. The xSP server (A), (B) 0116, after being authenticated by the subscriber authentication server 0102 based on the subscriber identification information of the xSIM card 0117, accesses each of the various network functions 0105 through the network function gateway server 0104 and thus uses the services. In this process, the network function gateway server 0104 takes charge of the charge information generation process. The network topology and architecture of the fixed communication carrier network/internet 0114 are not limited to a specified package. This embodiment presupposes the internet and the network managed by the communication carrier.

The subscriber authentication server 0102 is equivalent to a server authenticated in the case where the user of the portable terminal 0204 uses the network function group 0105. As far as the xSP server (A), (B) 0116 is concerned, it is authenticated by the subscriber authentication server with the same mechanism as the portable terminal 0204 from the subscriber identification information of the SIM card 0117. The existing xSP server 0118 is authenticated by the conventional third-party management server 0103. Before the existing xSP server 0118 provides the service, a heavy burden is imposed by the procedure including the process to examine the provider for registration and register the third-party management system. Further, in the case where the existing xSP server 0118 uses the network function group 0105, a positive mechanism for authentication and charging is required. The third-party management system is required to have such a mechanism. The secure authentication and charge information can be easily acquired, however, by application of the authentication/charge base of the user of the portable terminal 0204 included in the communication carrier to the xSP server (A), (B) using the xSIM card. In this way, the overhead of the paperwork process to be executed by the service provider xSP is reduced.

The network function gateway server 0104 acts as a control unit for controlling the service functions to make widely available for the service provider 0115 to use the network services of the communication carrier such as the position information 0106, the SMS-push 0107, the access filtering 0108, the E-mail 0109, the Web-gateway 0110, the voice communication 0111, the emergency notification 0112 and the chat 0113. This embodiment includes an access control process 1502, a SLA maintenance control process 1503, a service use IF generation/execution process 1504 and a CDR generation process 1505. The processing functions of the network function gateway server 0104 are not limited to these processes, and the processing function can be added or can include a different function. The wide availability of these service functions through the network function gateway server 0104 may permit the existing network functions of the communication carrier to produce additional profits.

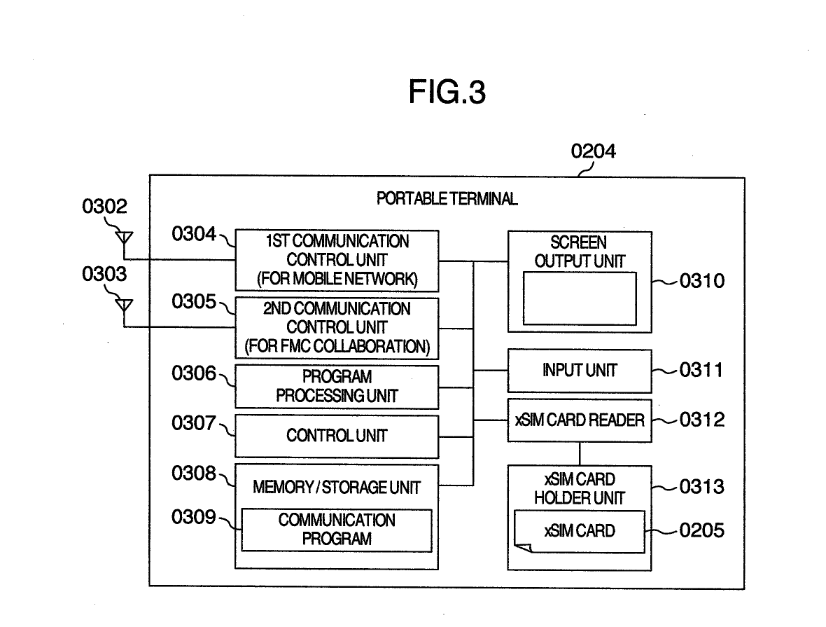

FIG. 3 shows an example of the hardware configuration of the portable terminal 0204. An example is explained below in which a xSIM card is used as a SIM card. A first communication control unit (for the mobile network) 0304 controls the communication for connecting to the mobile communication carrier network. A specific processing system can be packaged in similar way to that of the portable phone terminal. The radio communication interface 0302 is connected with the first communication control unit (for the mobile network) 0304, and can be packaged similarly to the transmission/reception antenna of the portable phone. A second communication control unit (for collaboration with FMC) 0305, on the other hand, is for connecting to the xSP server (A) 0116. The radio communication interface 0303 is connected with the second communication control unit (for collaboration with FMC) 0305, and can be packaged similarly to the transmission/reception antenna of Bluetooth or the external connector of the portable phone. The program processing unit 0306 is a processor for executing (computing) the program on the memory, and can be implemented by a multipurpose processor such as a CPU. The control unit 0307 manages each function unit connected to the bus, controls the data transfer timing or otherwise controls the overall process of the system. The memory (storage unit) 0308 records the communication program 0309.

A screen output unit 0310 is used for outputting and displaying the information to the user on the screen, and can be implemented by a liquid crystal screen or the like. An input unit 0311 is used for inputting a program start command or the like from the user and can be implemented by a keyboard or the like. An xSIM card reader 0312 is a device for reading the information recorded in the xSIM card 0205 stored in the xSIM card holder unit 0313, and can be implemented similarly to the portable terminal 0204. The xSIM card holder unit 0313 is a device for storing the xSIM card 0205 and connecting to the xSIM card reader 0313, and can be implemented similarly to the portable terminal 0204. The communication program 0309 is recorded in the memory 0308, and indicates the procedure for the communication between the process and the communication program 0508 included in the xSP server (A) 0116.

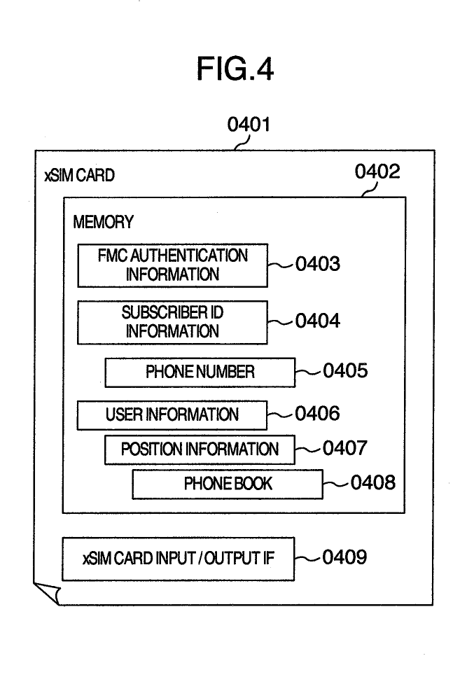

FIG. 4 shows an example of the hardware configuration of the xSIM card 0401 and the data stored in the xSIM card 0401. All the data are held in the memory 0402, and all the fields (0403 to 0408) can be read. The FMC authentication information 0403 is stored as the session information after authentication in collaboration with the FMC technique. The subscriber identification information 0404 and the phone number 0405 are stored as the identification information assigned uniquely to each subscriber. The user information 0406 such as the position information 0407 and the phone book 0408 is the data held for the subscribers. The xSIM card input/output IF 0409 is an IF used for reading/writing the data on the memory 0402. The architecture for the data stored in the xSIM card 0401 is not limited to a specified package. This embodiment presupposes the use of the USIM (Universal Subscriber Identity Module) card or the like.

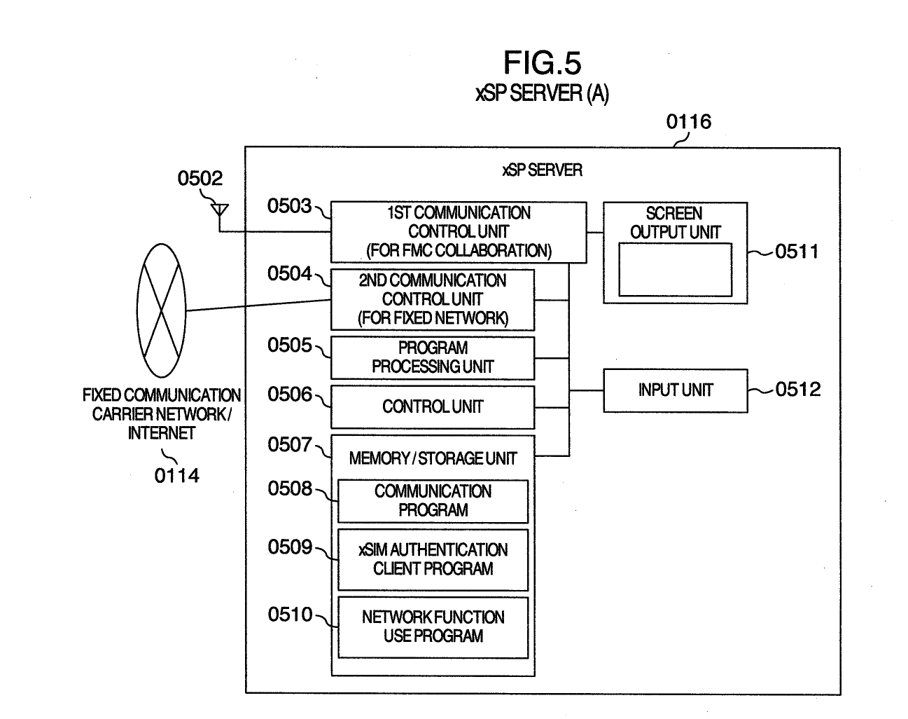

FIG. 5 shows an example of the hardware configuration and the package program of the xSP server (A) 0116. The first communication control unit (for collaboration with FMC) 0503 controls the communication for connecting to the second communication control unit (for collaboration with FMC) 0305 of the portable terminal 0204. A specific processing system can be packaged similarly to that of the portable terminal 0204, i.e. similarly to the transmission/reception antenna of Bluetooth or the external connector of the portable phone. The radio communication interface 0502 is connected to the first communication control unit (for collaboration with FMC) 0503. The second communication control unit (for the fixed network) 0504, on the other hand, controls the communication for connecting to the fixed communication carrier network/internet 0114. A specific processing system can be packaged similarly to the network interface connector for the personal computer.

The program processing unit 0505 is a processor for executing (computing) the program on the memory, and can be implemented by a multipurpose processor such as the CPU. The control unit 0506 manages each function unit connected to the bus or controls the whole process of the system including the data transfer timing. The memory (storage unit) 0507 records the communication program 0508, the xSIM authentication client program 0509 and the network function use program 0510. The screen output unit 0511 is used to output and display the information to the user on the screen, and can be implemented by a liquid crystal screen or the like. The input unit 0512 is used for inputting a program start command from the user, and can be implemented by a keyboard or the like. The communication program 0508 is recorded in the memory 0507 and indicates the procedure for communication between the process and the communication program 0309 contained in the portable terminal 0204.

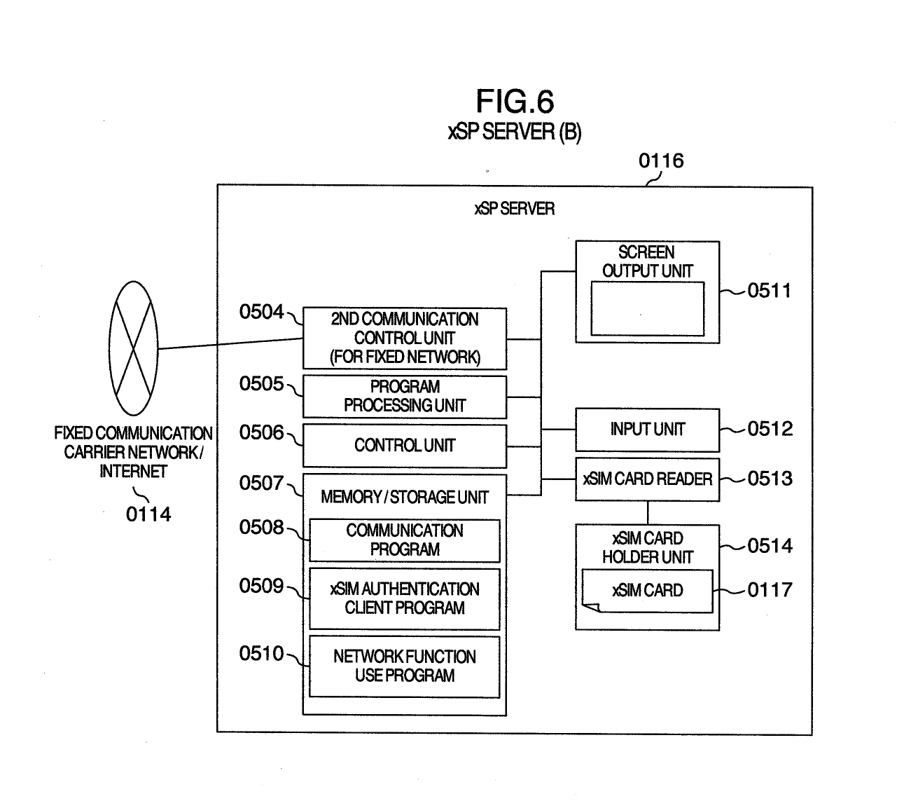

FIG. 6 shows an example of the hardware configuration and the package program of the xSP server (B) 0116. The communication control unit 2 (for the fixed network) 0504 controls the communication for connecting to the fixed communication carrier network/internet 0114. A specific processing system can be packaged similarly to the network interface connector for the personal computer.

The program processing unit 0505 is a processor for executing (computing) the program on the memory, and can be implemented by a multipurpose processor such as a CPU. The control unit 0506 manages each function unit connected to the bus or controls the overall process of the system including the data transfer timing, and can be packaged by the conventional technique. The memory (storage unit) 0507 records the communication program 0508, the xSIM authentication client program 0509 and the network function use program 0510. The screen output unit 0511 is used for outputting and displaying the information to the user on the screen, and can be implemented by a liquid crystal screen or the like. The input unit 0512 is used for inputting a program start command or the like from the user and can be implemented by a keyboard or the like. The xSIM card reader 0513 is a device for reading the information recorded in the xSIM card 0117 stored in the xSIM card holder unit 0514, and can be implemented similarly to the portable terminal 0204. The xSIM card holder unit 0313 is a device for storing the xSIM card 0117 and connecting to the xSIM card reader 0513, and can be implemented similarly to the portable terminal 0204.

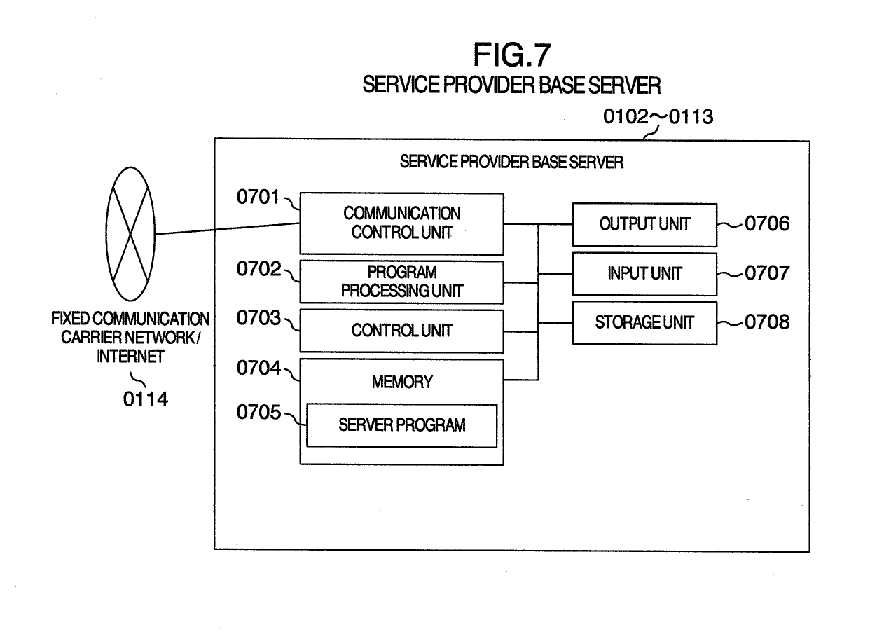

FIG. 7 shows the main hardware configuration and functions of the servers arranged on the communication carrier service provider base 0101. The communication control unit 0701 controls the communication for connecting to the fixed communication carrier network/internet 0114. A specific processing system can be packaged similarly to the network interface connector for the personal computer.

The program processing unit 0702 is a processor for executing (computing) the program on the memory, and can be implemented by a multipurpose processor such as a CPU. The control unit 0703 manages each function unit connected to the bus or controls the data transfer timing or otherwise controls the overall process of the system, and can be packaged by the conventional technique. The memory 0704 records the server program 0705. The output unit 0706 is used to output and display the information to the user on the screen, and can be implemented by a liquid crystal screen or the like. The input unit 0707 is used for inputting a program start command or the like from the user, and can be implemented by a keyboard or the like. The server program 0705 is recorded in the memory 0704 and indicates the procedure for communication between the process and the communication program 0701 contained in the service provider base server.

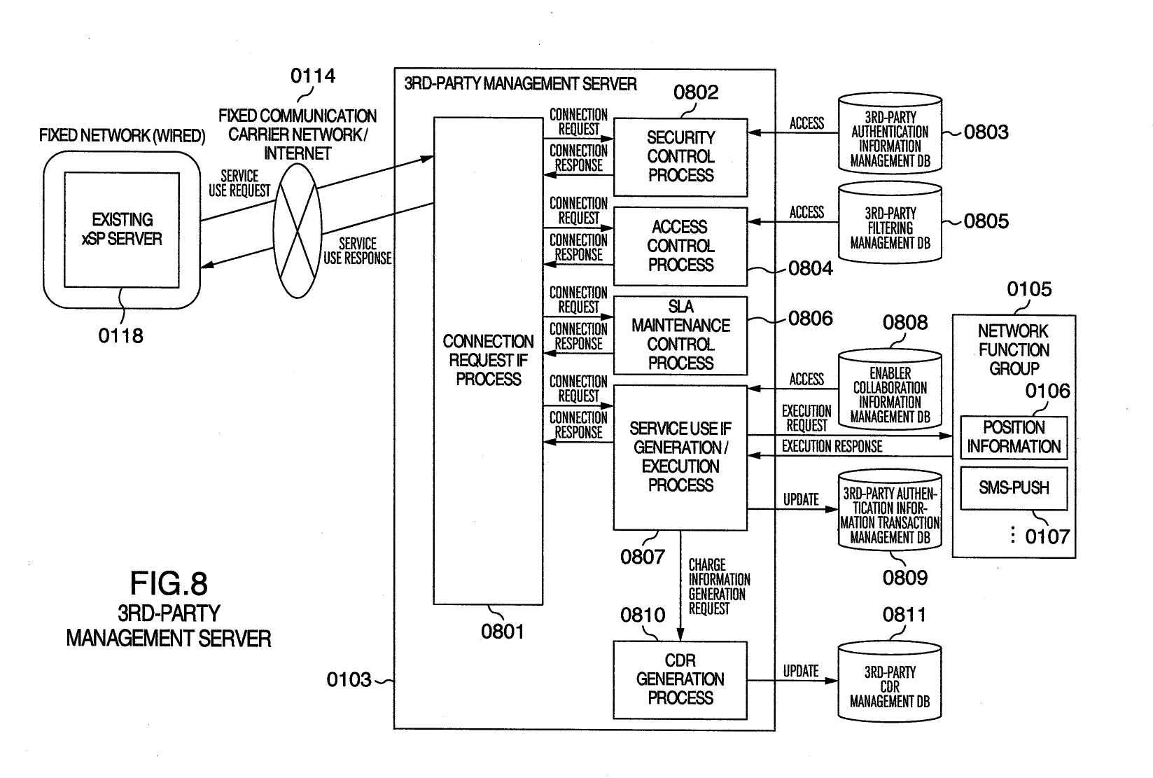

FIG. 8 shows the function blocks of the third-party management server 0103 of the communication carrier. The network topology and the architecture are not limited to a specific package. The third-party management server 0103 is connected to the existing xSP server 0118 through the fixed communication carrier network/internet 0114. A connection request is received by a connection request IF processing means 0801. A security control processing means 0802 receives the connection request from the connection request IF processing means 0801. After that, the connection request is authenticated based on the authentication information of the third-party authentication information management data base 0803 registered in advance. The access control processing means 0804 accesses the third-party filtering management data base 0805, and applies the filtering condition to the third party. The SLA maintenance control means 0806 maintains the SLA (service level agreement; service quality guarantee) with the limitation factors such as the service use achievement value and the traffic threshold value. The service use generation/execution processing means 0807 accepts the connection request from the connection request IF processing means 0801, and by acquiring the subscriber identification information and the existing xSP use service menu from the contents of the session information, retrieves the network function means 0105 required for the service to the existing xSP server from the enabler collaboration information management data base 0808. After that, the IF required for using the network function means 0105 is generated and executed. The result of execution is returned to the connection request IF processing means 0801, and the result of using the network function to the existing xSP server 0118.

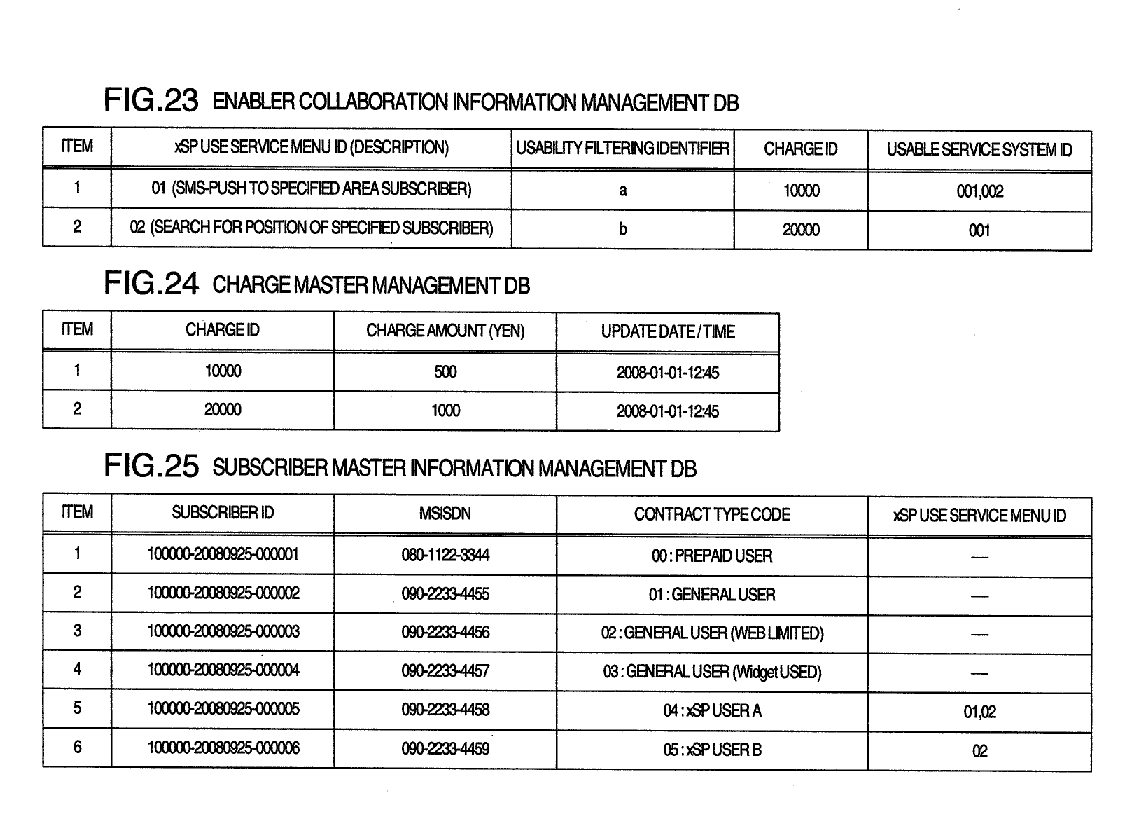

FIG. 23 is a diagram showing an example of the table of the enabler collaboration information management data base 0808. The table columns are configured of an xSP use service menu ID, a usable filtering identifier, charge ID and a use service system ID. The xSP use service menu ID is the number corresponding uniquely to the service menu provided by the service provider xSP. As a usability filtering identifier, the service menu usable is determined for each type of the contract of the service provider xSP and defined for each xSP use service menu ID. In accordance with this usability filtering identifier, the usability of the service provider xSP is controlled. The charge ID is the number assigned to each charge amount for each xSP use service menu ID. Each time the service menu is used, the charge amount corresponding to this charge ID is charged on the service provider xSP. The use service system ID defines the network function system required at the time of using the xSP use service menu. In FIG. 23, for example, assume that the service menu ID “01” indicating “SMS push to specified area subscriber”. The use service system turns to “001 (assumed as the position information system), 002 (assumed as the SMS push system)”, and the network function gateway server 0104, in accordance with this ID, accesses the required system in the network function group 0105.

In FIG. 8, the position information 0106 and the SMS push 0107 are executed. In the case where the result of normal execution is obtained, the history of access to the third-party management information transaction management data base 0809 is updated. After returning the execution result response to the existing xSP server, the CDR generation processing means 0810 is executed and the CDR is generated in the third-party CDR management table.

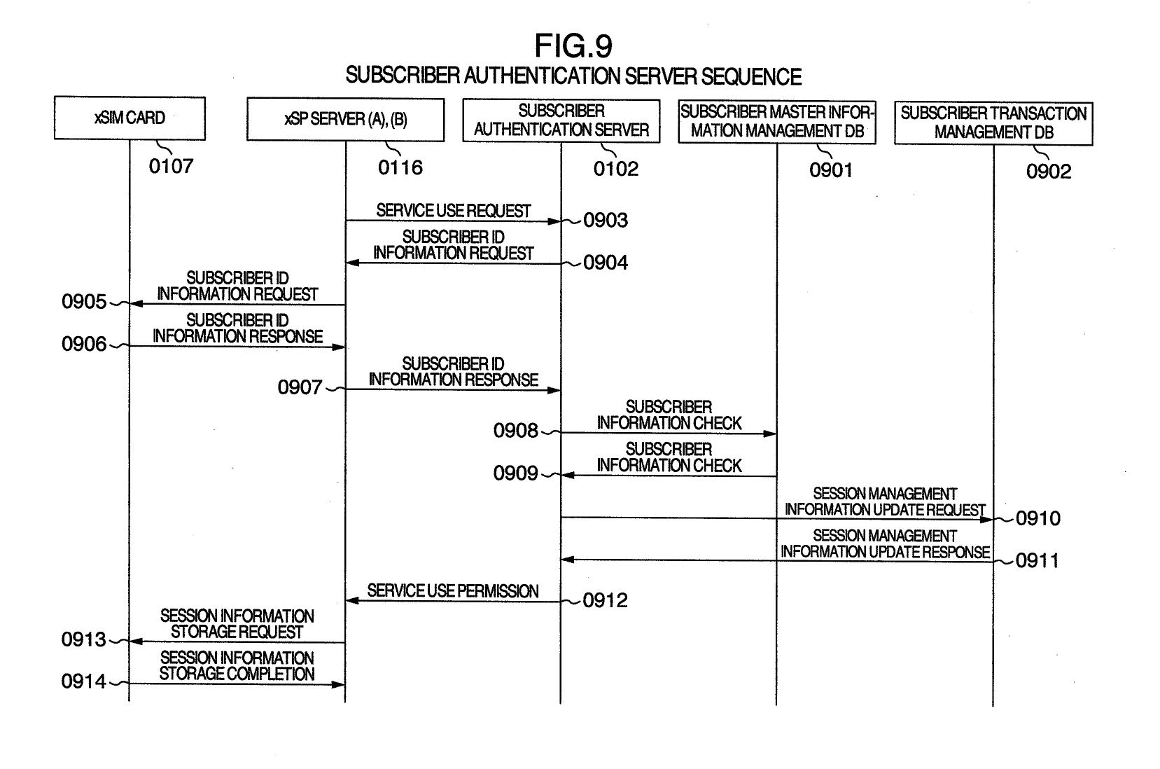

FIG. 9 shows the subscriber authentication server sequence for authenticating the xSP server (A), (B) 0116 in the xSIM card 0107. The xSP server (A), (B) 0116 issues a service use request 0903. The subscriber authentication server 0102 that has received the service use request 0903 issues a subscriber identification information request 0904 to the xSP server (A), (B) 0116. The xSP server (A), (B) 0116 accepts the subscriber identification information response 0906 at the subscriber identification information request 0905 from the xSIM card 0107, and thus obtains the identification information on the service provider xSP. The subscriber authentication server 0102 that has received the subscriber identification information performs the subscriber information check 0908 by accessing the subscriber master information management data base 0901. After the subscriber information check 0909 is successfully performed, the subscriber authentication server 0102 writes the session management information update request 0910 such as the connection status, the transaction ID, the session key and the session key deadline from the session information into the subscriber transaction management data base 0902. The subscriber transaction management table 0902 returns the session management information update response 0911 to the subscriber authentication server 0102. After that, the subscriber authentication server 0102 returns the service use permit 0912 to the xSP server (A), (B) 0116. The xSP server (A), (B) 0116 issues a session information storage request 0913 to the xSIM card through the portable terminal 0204 or the fixed terminal, and writes it into the xSIM card 0107. After that, the xSP server (A), (B) 0116 accepts the session information storage completion signal 0914.

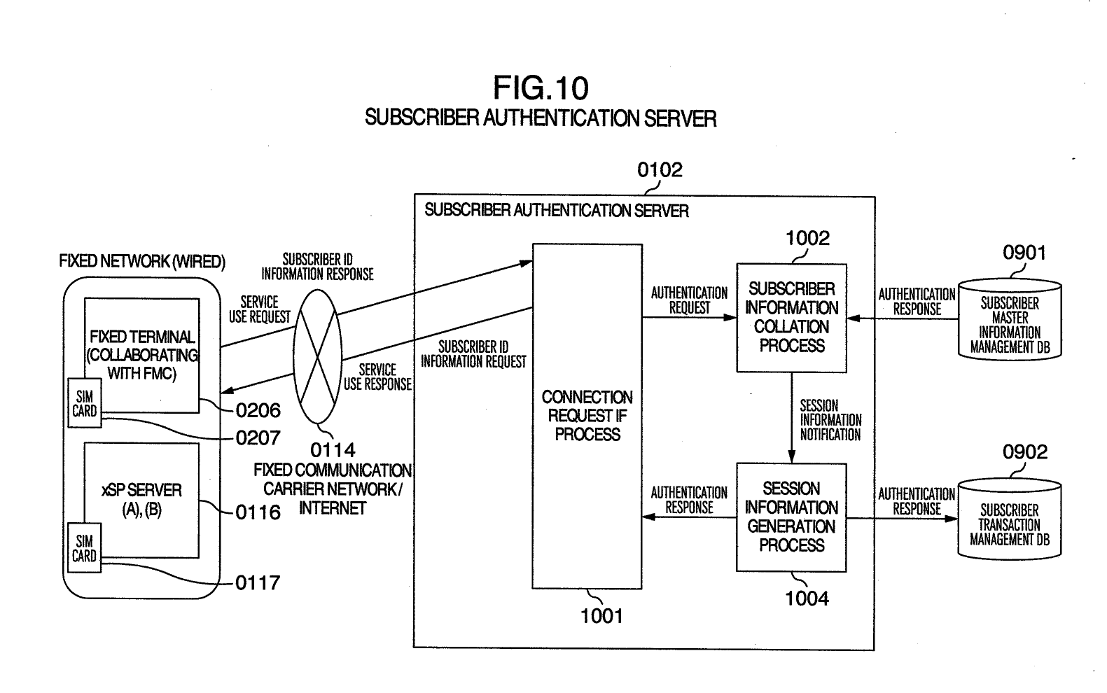

FIG. 10 shows the function blocks of the subscriber authentication server 0102. The subscriber authentication server 0102 is connected, through the fixed communication network/internet 0114, to the fixed network connected with the fixed terminal (in collaboration with FMC) 0206 having the xSIM card 0207 and the xSP server (A), (B) 0116 having the xSIM card 0117. First, the connection request IF processing means 1001 receives a connection request from the xSP server (A), (B) 0116. The subscriber information collation processing means 1002, upon reception of the connection request from the connection request IF processing means 1001, searches the subscriber master information management data base 0901 and thus authenticates by identification of the service provider xSP based on the subscriber identification information recorded in the xSIM card 0117. After authentication by identification, the session information is complemented with the information from the subscriber master information management data base 0901, and the session information is generated by the session information generation processing means 1004. After generation of the session information, the use history in the subscriber transaction management data base 0902 is updated, and the authentication response is returned to the connection request IF processing means 1001. Finally, the service use response result is returned to the xSP server (A), (B) 0116 from the connection request IF processing means 1001. FIG. 25 is a diagram showing an example of the table of the subscriber master information management data base 0901. The table columns are configured of the subscriber ID, the MSISDN, the contract type code and the xSP use service menu ID. The subscriber ID is the number corresponding uniquely to the subscriber (including the service provider xSP) having the xSIM cards 0205, 0207, 0117. The MSISDN is a phone number. The contract type code is the number for identifying the contract type for subscription. The input values include “00” for the prepaid user, “01” for the general user, “02” for the general user (limited by WEB), “03” for the xSP user A, and “04” for the xSP user B. In the case where the network function is used by a service provider xSP, the contract is required to be signed with the subscription contract type code 03, 04. The xSP use service menu ID is the number set in correspondence with the service menu for using the network function prepared by the communication common carrier in the case where the xSP subscribes as a service provider. At the time of subscription, the service provider xSP signs a contract by selecting the service menu required to provide the service. The contract type code and the range of use are varied depending on the number of the use service menus.

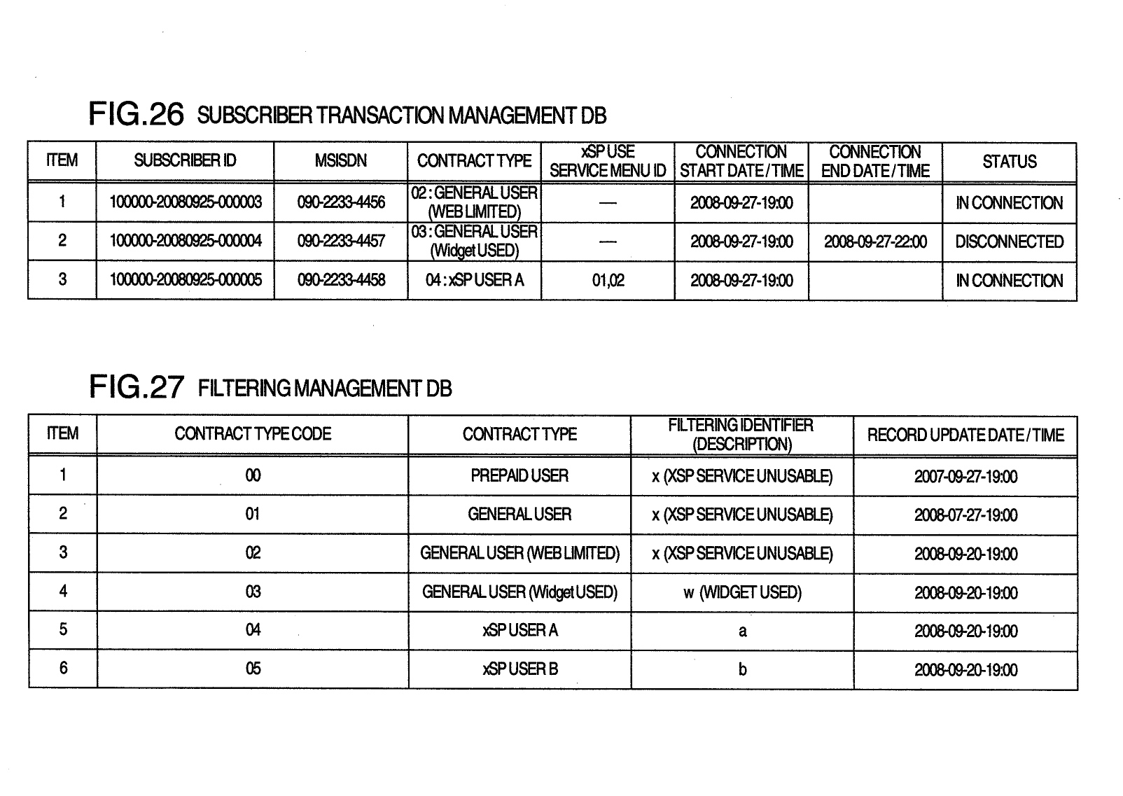

FIG. 26 is a diagram showing an example of the table of the subscriber transaction management data base 0902. The columns of this table, in addition to the column of the subscriber master information management data base, are configured of the connection start date/time, the connection end date/time, the status, the transaction ID, the session key, the session key deadline and the record update date/time. The current date/time of the authentication granted to the subscriber in accessing the service provider base is input as the connection start date/time. The current date/time at which the access to the service provider base ends is input as the connection end date/time. The present situation of the subscriber is input as the status. As shown in item 2, “in connection” is input in the case where the service provider base is being used. The information obtained by the session information generation process 1004 are input as the transaction ID, the session key and the session key deadline. The current date/time is input as the record update date/time each time the record is updated.

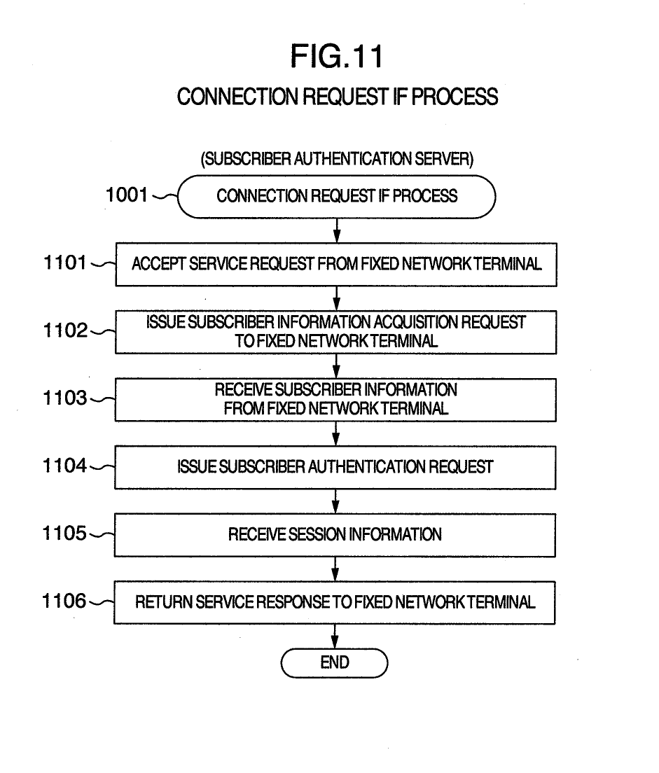

FIG. 11 is a diagram showing the processing flow of the connection request IF processing means 1001 in the subscriber authentication server 0102. The subscriber authentication server 0102 accepts the service request from the fixed network terminal through the process (1001) of the connection request IF (1101), and transmits a subscriber information acquisition request to the fixed network terminal (1102), followed by receiving the subscriber information from the fixed network terminal (1103). Then, the subscriber authentication server 0102 transmits a subscriber authentication request (1104), and receives the session information (1105). Based on this information, a service response is transmitted to the fixed network terminal (1106).

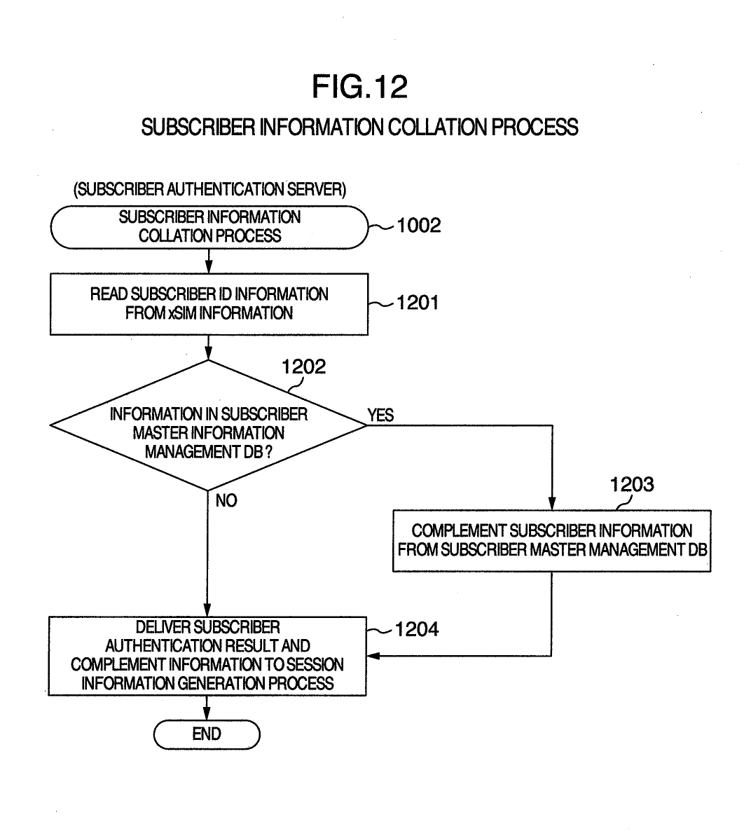

FIG. 12 is a diagram showing the processing flow of the subscriber information collation processing means 1002 in the subscriber authentication server 0102. The subscriber identification information stored in the xSIM card is read (1201), and the subscriber master management data base is searched for the information corresponding to the subscriber identification information (1202). In the case where the particular information is stored in the subscriber master management data base, the subscriber information is complemented from the subscriber master management data base (1203). In the process, the contract type information indicating whether the subscriber is a prepaid user, a general user or a service provider and the service menu identification information registered by the service provider in advance are read from the subscriber master management data base thereby to complement the session information. In the case where the particular information is not stored in the subscriber master management data base, on the other hand, the subscriber authentication result and the complement information are transmitted to the session information generation processing means (1204).

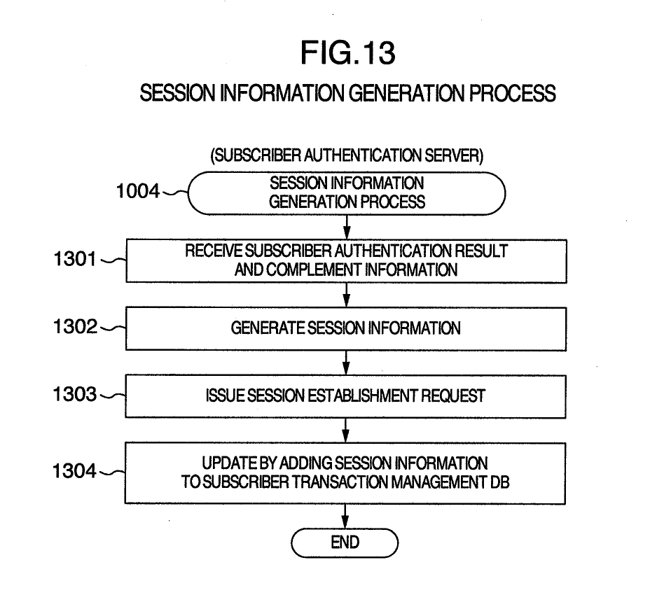

FIG. 13 is a diagram showing the processing flow of the session information generation processing means 1004 in the subscriber authentication server 0102. Upon reception of the subscriber authentication result and the complement information from the subscriber information collation processing means (1301), the session information is generated (1302). The session information may be generated in correspondence with the identifier of the authenticated subscriber in such a manner as to include the transaction identifier, the session key used for communication encryption and the session deadline. Also, the usability message of each one of the network functions may include the session information. Then, a session establishment request is transmitted (1303), and the subscriber transaction management data base is updated by adding the session information (1304).

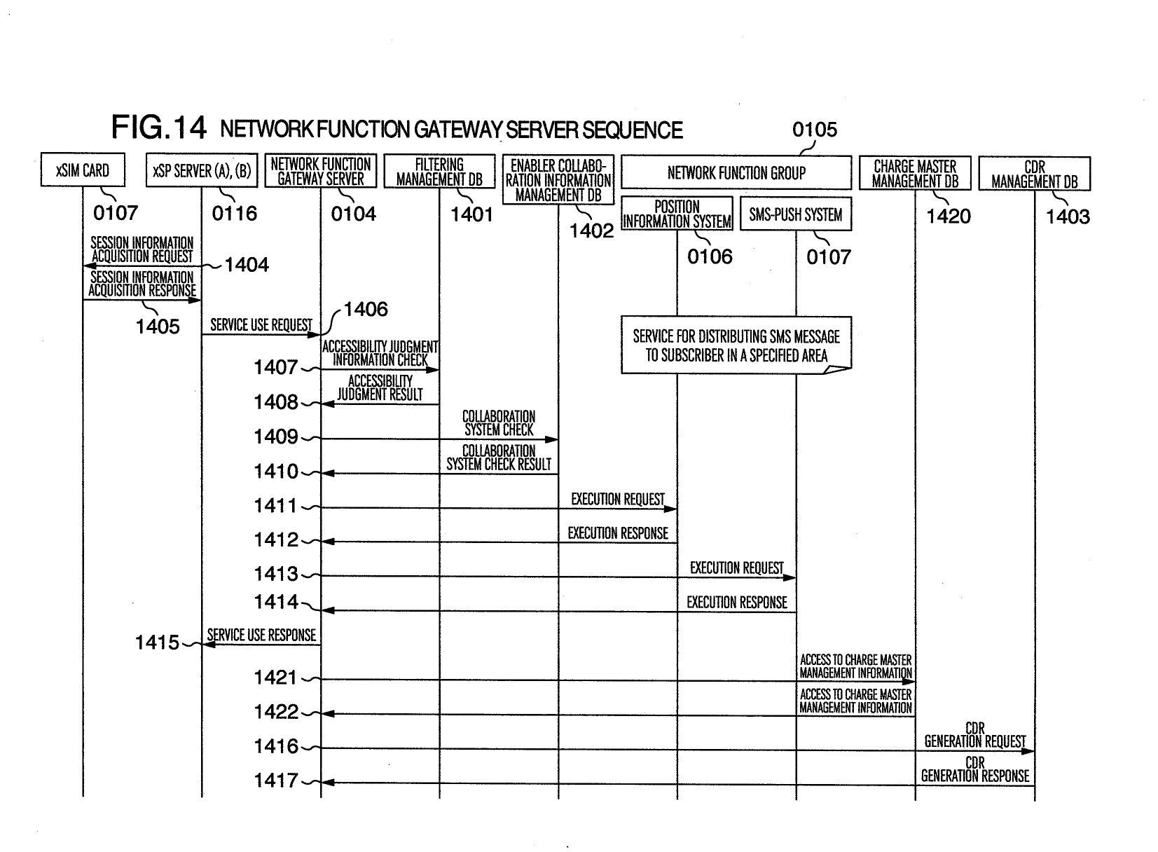

FIG. 14 is a diagram showing the sequence of the service use request and the response in the network function gateway server 0104. The xSP server (A), (B) 0116 issues the session information acquisition request 1404. The xSIM card 0107 that has received a session information acquisition request 1404 sends the session information acquisition response 1405 to the xSP server (A), (B) 0116. The xSP server (A), (B) 0116 transmits a service use request 1406 to the network function gateway server 0104. The network function gateway server 0104 sends an accessibility judgment information check signal 1407 to the filtering management data base 1401, and receives the accessibility judgment result 1408 from the filtering management data base 1404. The network function gateway server 0104 further transmits a collaboration system check signal 1409 to the enabler collaboration information management data base 1402 and receives the collaboration system check result 1410. The network function gateway server 0104 further transmits execution requests 1411, 1413 to the SMS push system 0107 and the position information system 0106 of the network function group 0105, and receives execution responses 1412, 1414. In the step for executing the network function, the usability of the network function is judged based on the contract type information contained in the session information. Also, the usability of each network function and the charge rule may be determined based on the service menu identifier information of the session information. Through these steps, the network function gateway server 0104 transmits a service use response 1415 to the xSP server (A), (B) 0116. Then, the network gateway server 0104 transmits a charge master management information access signal 1421 and a CDR generation request 1416 to the charge master management data base 1420 and the CDR management data base 1403, respectively, on the one hand and receives a charge master management information access response 1422 and a CDR generation response 1417, respectively, on the other hand.

FIG. 27 is a diagram showing an example of the table of the filtering management data base 1401. The columns of this table are configured of the contract type code, the contract type, the filtering identifier and the record update date/time. The contract type code has a similar meaning to the corresponding column of the subscriber master information management data base. The meaning of the contract type code is input as the contract type. The filtering identifier indicates the range in which the xSP use service menu is used for each contract type of the service provider xSP. In FIG. 27, the filtering identifier of the xSP user A in contract type is designated as “a”, and the filtering identifier of the xSP user B in contract type as “b”. The xSP use service menu can be used in the case where the filtering identifier is included in the usable filtering identifier column data of the enabler collaboration information management data base.

FIG. 24 is a diagram showing an example of the table of the charge master management data base 1420. The columns of this table are configured of the charge ID, the charge amount and the update date/time. The charge ID has a similar meaning to the charge ID of the enabler collaboration information management data base. The charge amount is the one for each charge ID. The record update date/time is input as the update date/time. In the case where the charge amount is reviewed, for example, the update date/time column is updated.

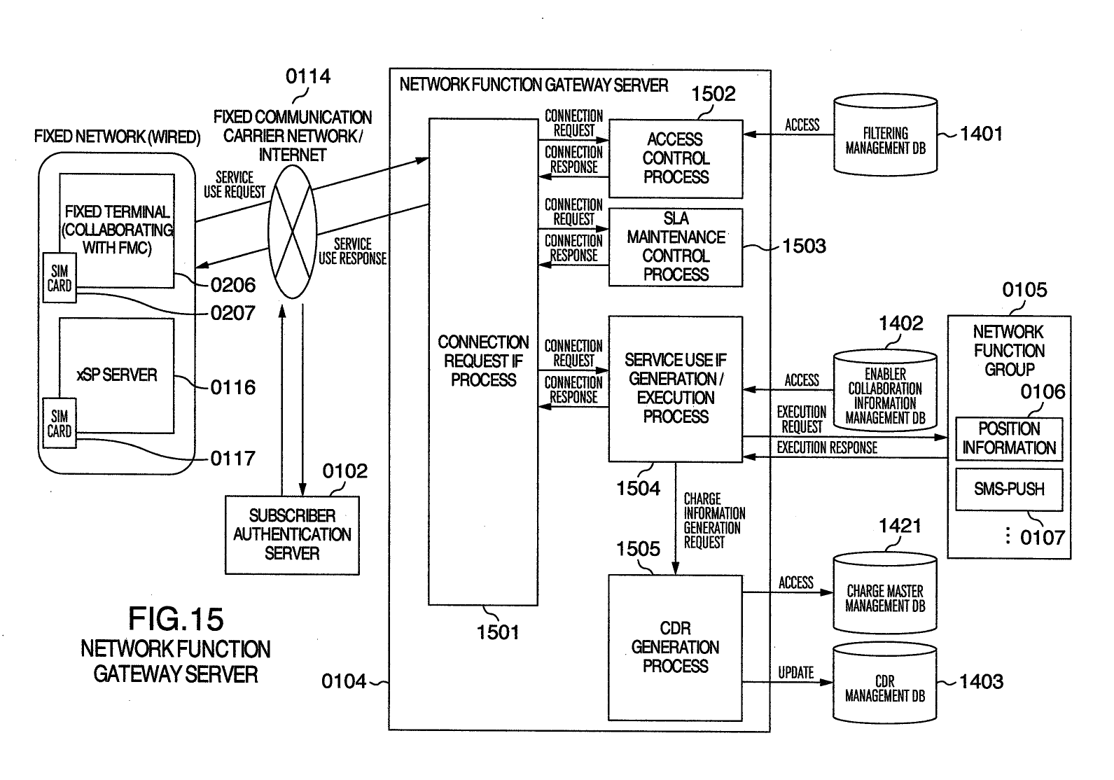

FIG. 15 is a diagram showing the function blocks in the network function gateway server 0104. The network function gateway server 0104 is one of the servers arranged on the communication common carrier service provider base 0101 connected, through the fixed communication carrier network/internet 0114, to the fixed network connected to the fixed terminal (in collaboration with FMC) 0206 having the xSIM card 0207 and the xSP server (A), (B) 0116 having the xSIM card 0117. The xSP server (A), (B) 0116 permitted to use the service as the result of authentication by the subscriber authentication sever 0102 issues a service request to the connection request IF process 1501. The access control process 1502 applies the filtering condition by accessing the filtering management data base 1404. The SLA maintenance control unit 1503 maintains the SLA based on the limitation policy using the service use achievement value and the traffic threshold value. The service use IF generation/execution process 1504, after being permitted to use the service by the control process described above, receives a connection request from the connection request IF process 1501, and by acquiring the subscriber identification information and the xSP use service menu from the session information, retrieves the required network function 0105 from the enabler collaboration information management data base 0808. At the time of using the network function 0105, the required IF is generated and the network function executed. The execution result is returned to the connection request IF process 1501, and the network function use result to the xSP server (A), (B) 0116. In the case of FIG. 15, the position information 0106 and the SMS push 0107 are executed. The CDR generation processing unit 1505, after returning the network function use response to the xSP server (A), (B) 0116, and in the case where the network function use response result is normal, accesses the charge master management data base 1420 and generates the CDR for the CDR management data base 1403.

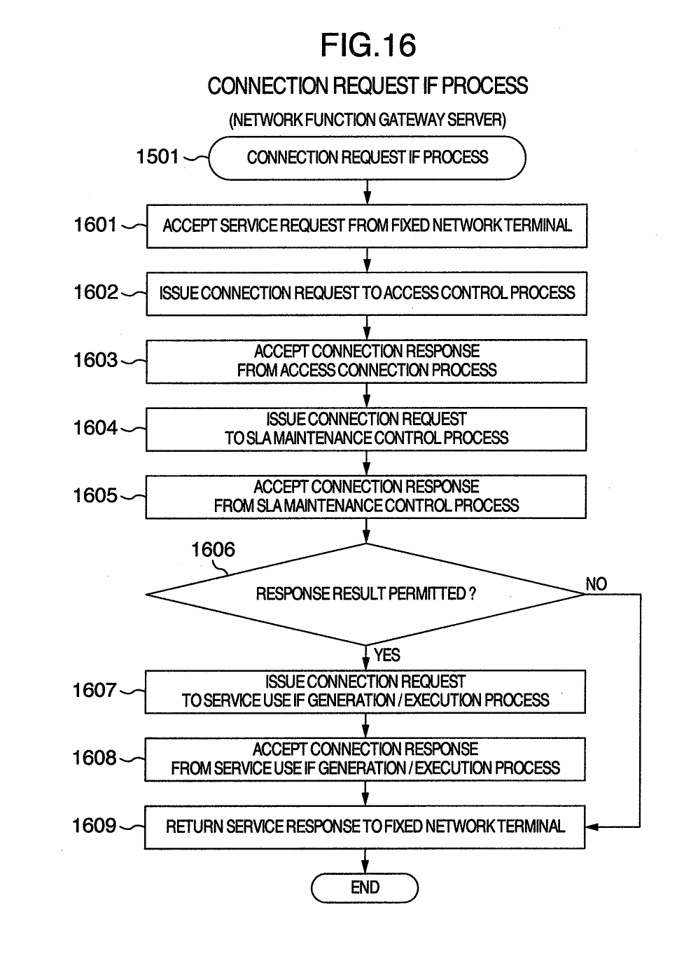

FIG. 16 is a diagram showing the processing flow of the connection request IF processing means 1501 in the network function gateway server 0104. A service request from the fixed network terminal is accepted (1601), a connection request is transmitted to the access control processing means 1502 (1602), and a connection response is accepted from the access control processing means 1502 (1603). A connection request is transmitted to the SLA maintenance control processing means 1503 (1604), and a connection response is received from the SLA maintenance control processing means 1503 (1605). In the case where the response result indicates the permission, a connection request is transmitted to the service use IF generation/execution processing means 1504 (1607), and a connection response is received from the service use IF generation/execution processing means 1504 (1608). Then, a service response is transmitted to the fixed network terminal (1609). In the case where the response result is not the permission, on the other hand, the service response is transmitted to the fixed network terminal (1609).

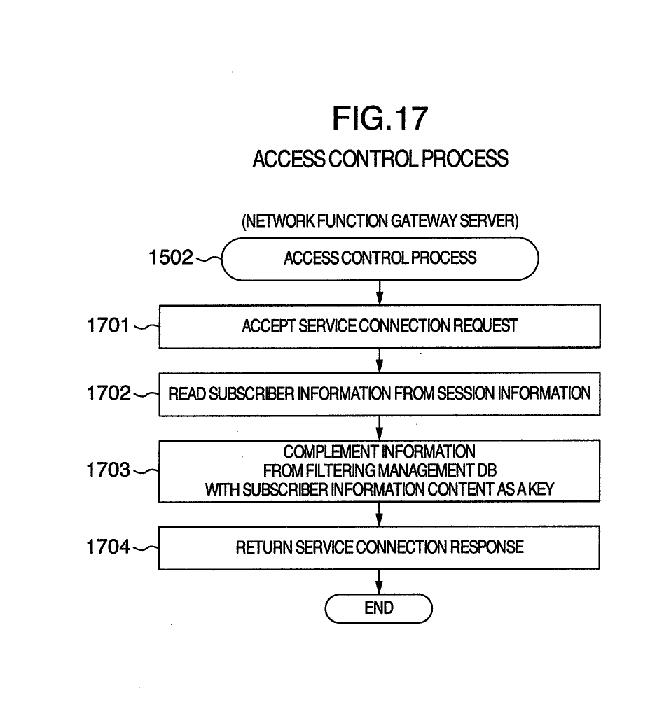

FIG. 17 is a diagram showing the processing flow of the access control processing means 1502 in the network function gateway server 0104. Upon acceptance of the service connection request (1701), the subscriber information contained in the session information is read (1702), the information is complemented from the filtering management data base based on the subscriber information (1703), and a service connection response is transmitted (1704).

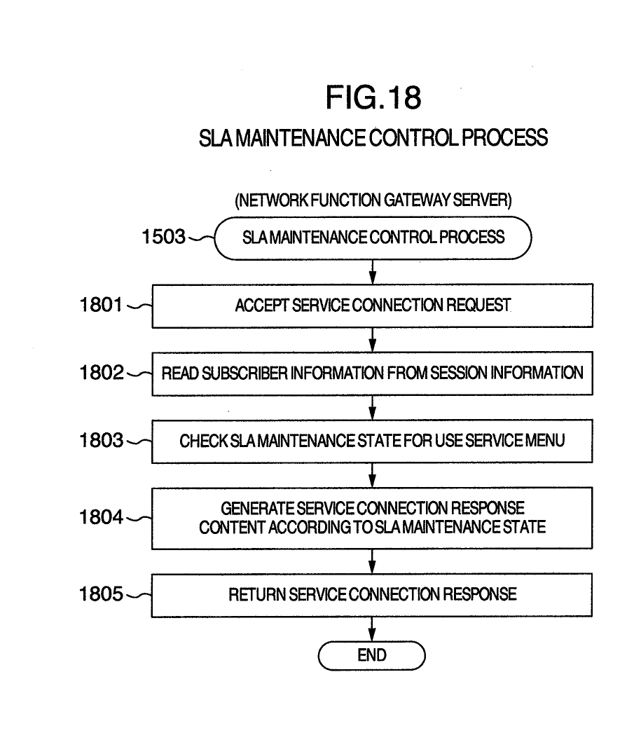

FIG. 18 is a diagram showing the processing flow of the SLA maintenance control processing means 1503 in the network gateway server 0104. Upon acceptance of the service connection request (1801), the subscriber information contained in the session information is read (1802), the SLA maintenance condition of the service menu used by the subscriber is confirmed (1803), the service connection response is generated based on the SLA maintenance state (1804), and a service connection response is transmitted (1805).

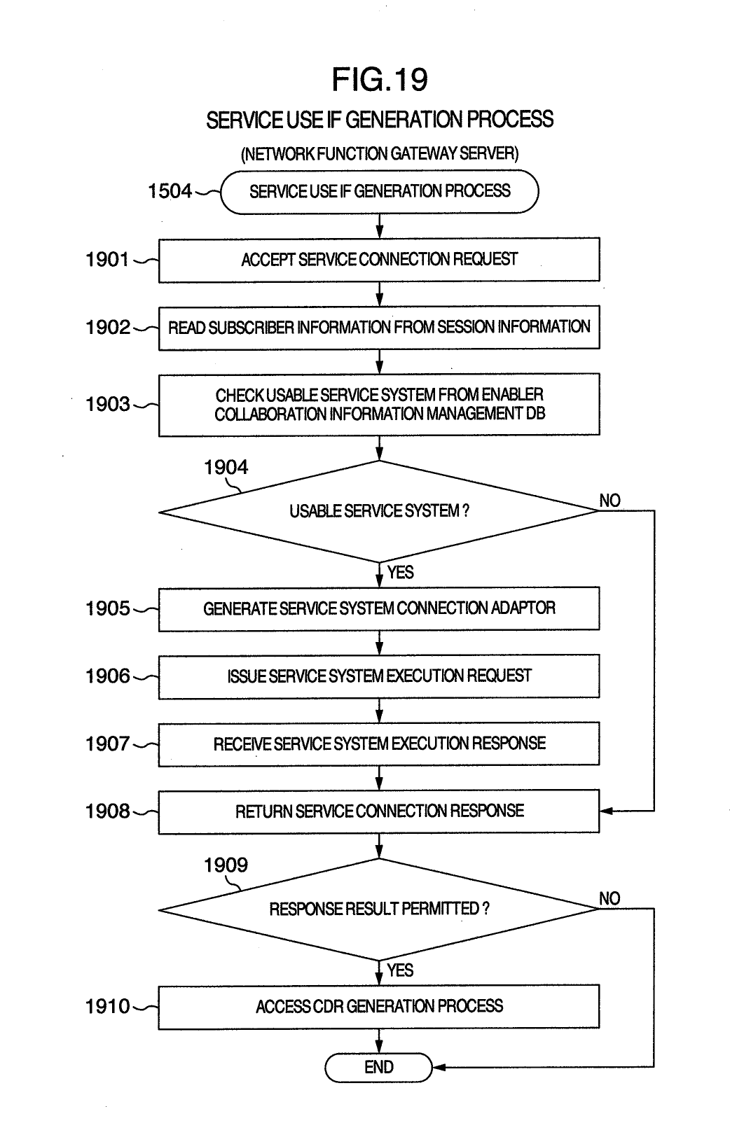

FIG. 19 is a diagram showing the processing flow of the service use IF generation processing means 1504 in the network function gateway server 0104. Upon acceptance of a service connection request (1901), the subscriber information contained in the session information is read (1902), and the usable service system is confirmed from the enabler collaboration information management data base (1903). In the case where a usable service system is available, a service system connection adaptor is generated (1905), a service system execution request is transmitted (1906), a service system execution response is received (1907), and a service connection response is transmitted (1908). In the absence of a usable service system, on the other hand, a service connection response is transmitted (1908). Once the service response result is permitted, an execution command is transmitted to the CDR generation processing means (1910). In the case where the service response result is not permitted, on the other hand, the process in the service use IF generation processing means is ended without transmitting the execution command to the CDR generation processing means.

Incidentally, before judgment of the service usability, the number of simultaneous connections of the xSP server or the number of the requests the use of the services (network functions) per unit time may be managed, and in the case where the number of simultaneous connections or the number of use requests exceeds a predetermined threshold value, the use of the service (network function) may not be permitted.

### Second Embodiment

The second embodiment represents an example of the system configuration in which in addition to the configuration of the first embodiment, the communication common carrier supplies the service provider with a simple application containing a program for accessing the network function, and the service user uses the service provided by the service provider. The network topology and architecture are not limited to a specified package but can be added or changed as required. This embodiment presupposes the Widget as the simple application containing a program for accessing the network function.

The portable terminal 0204 having the xSIM card 0205 corresponding to the service user 0203 is connected to the service provider base 0101 through the mobile communication carrier network 0202. The fixed terminal (in collaboration with FMC) 0206 having the xSIM card 0207 corresponding to the service user and the existing xSP server 0118 are connected to the service provider base 0101 through the fixed communication carrier network/internet 0114. The mobile communication carrier network 0202 and the fixed communication carrier network/internet 0114 are assumed to be the network managed by the communication common carrier.

The general user downloads the Widget 0208 provided by the service provider 0115. With the execution of the Widget 0208 on the screen of the portable terminal 0204 as a trigger, a service use request is issued to the xSP server (A), (B) 0116. The xSP server (A), (B) 0116 that has received the request is authenticated by the subscriber authentication server 0102, and uses the network functions by accessing the network function group 0105 through the network function gateway server 0104. In the process, the third-party management server 0103 takes charge of the charge information generation process.

The subscriber authentication server 0102, at the request of the subscriber having the xSIM cards 0205, 0207, 0117 to use the service, grants the authentication based on the subscriber identification information read by the direct connection using the portable terminal connector or the radio connection using Bluetooth from the xSIM cards 0205, 0207 and 0117. In radio connection, the subscriber information data held by the xSIM card 0205 is transferred between the radio communication interface 0303 of the second communication control unit (in collaboration with FMC) 0305 of the portable terminal 0204 and the radio communication interface 0502 of the first communication control unit (in collaboration with FMC) of the xSP server (A), (B) 0116.

The existing xSP server not having the xSIM card is authenticated by the third-party management server 0103 of the communication common carrier. After that, the network function group 0105 is accessed through the network function gateway server 0104 to use the network function. In the process, the third-party management server 0103 takes charge of executing the charge information generation process.

The network function gateway server 0104 operates in such a manner that the network functions of the communication common carrier including the position information 0106, the SMS push 0107, the access filtering 0108, the E-mail 0109, the Web-gateway 0110, the voice communication 0111, the emergency notification 0112 and the chat 0113 are made available to the service provider 0115 very conveniently and securely. This embodiment presupposes the Widget 0208 which is supplied with a travel destination and outputs a list of recommended inns/hotels. In addition to the output of the inn/hotel list, the Widget is assumed to display an advertisement as required. The subscriber to the portable terminal 0204, by clicking the desired inn/hotel from the inn/hotel list on display, issues a service use request to the xSP server (A), (B) 0116 and executes the network function of the voice communication 0111. In this way, the subscriber to the portable terminal 0204 can make a phone call to the particular hotel. By incorporating the mechanism using the network functions in the Widget, the use of the network functions is promoted, and the communication common carrier can obtain a greater profit with the existing equipment, while at the same time promoting the use of the network function gateway server 0104. Also, by carrying an advertisement on the Widget as in this embodiment, the number of times the advertisement is read can be counted from the number of times the Widget is executed, thereby permitting the service provider to gain a profit from the advertisement.

In the case where the communication common carrier distributes a model of the Widget to the service providers 0115, the development cost of the application for use of the network functions on the part of each service provider 0115 can be reduced, while at the same time increasing the number of the service providers providing the Widget, thereby further increasing the utilization rate of the network functions. Based on the Widget model, each service provider 0115 develops the Widget of its own and registers it in the Widget distribution server 0201. The Widget distribution server 0201 has the function of distributing the Widget to the general subscribers in addition to the function of managing the registered programs.

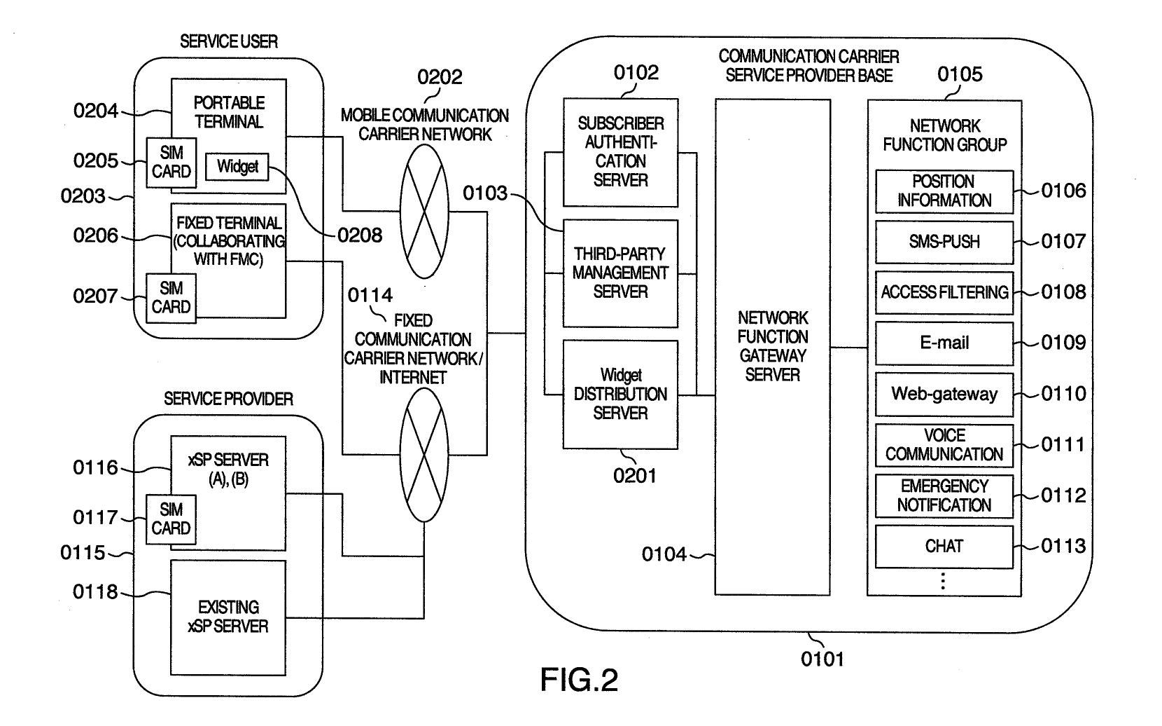

FIG. 2 shows an example of the system configuration in which the service provider xSP uses the communication carrier service provider base 0101 of the communication common carrier at the time of adding the configuration of the service user to the configuration shown in FIG. 1. The service user 0208 may include either the portable terminal 0204 or the fixed terminal 0206. The portable terminal 0204 includes the SIM card 0205 and the Widget (the software to form the graphical user interface) 0208. The fixed terminal 0204 is of FMC (fixed mobile convergence) collaboration type and includes the SIM card 0207. The portable terminal 0204 and the fixed terminal 0206 are connected to the communication carrier service provider base 0101 through the mobile communication carrier network 0202 and the fixed communication carrier network 0114, respectively. Incidentally, in FIG. 2, the communication carrier service provider base 0101 further includes a Widget distribution server 0201.

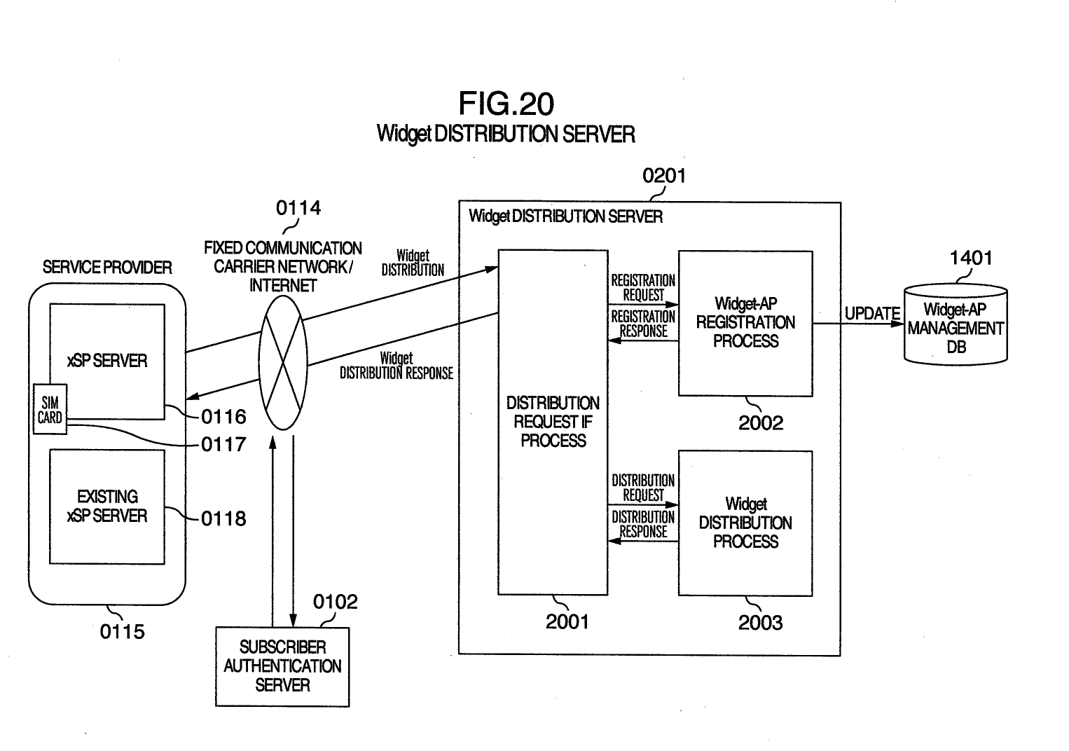

FIG. 20 is a diagram showing the function blocks of the Widget distribution server 0201. The Widget distribution server 0201 is connected to the xSP server (A), (B) 0116 having the xSIM card 0117 corresponding to the service provider 0115 and the existing xSP server 0118 through the fixed communication carrier network/internet 0114. The distribution request IF processing means 2001 accepts the Widget registration request and the Widget distribution request from the service provider 0115. The Widget-AP registration means 2002 is accessed by the Widget registration request of the distribution request IF processing means 2001 and uploads and records the Widget requested for registration from the service provider. Further, the Widget management information for each subscriber is registered in the Widget-AP management data base 1401. The Widget distribution processing means 2003 is accessed by the Widget distribution request of the distribution request IF processing means 2001 and distributes by downloading the Widget to the terminal screen of the service user 0203.

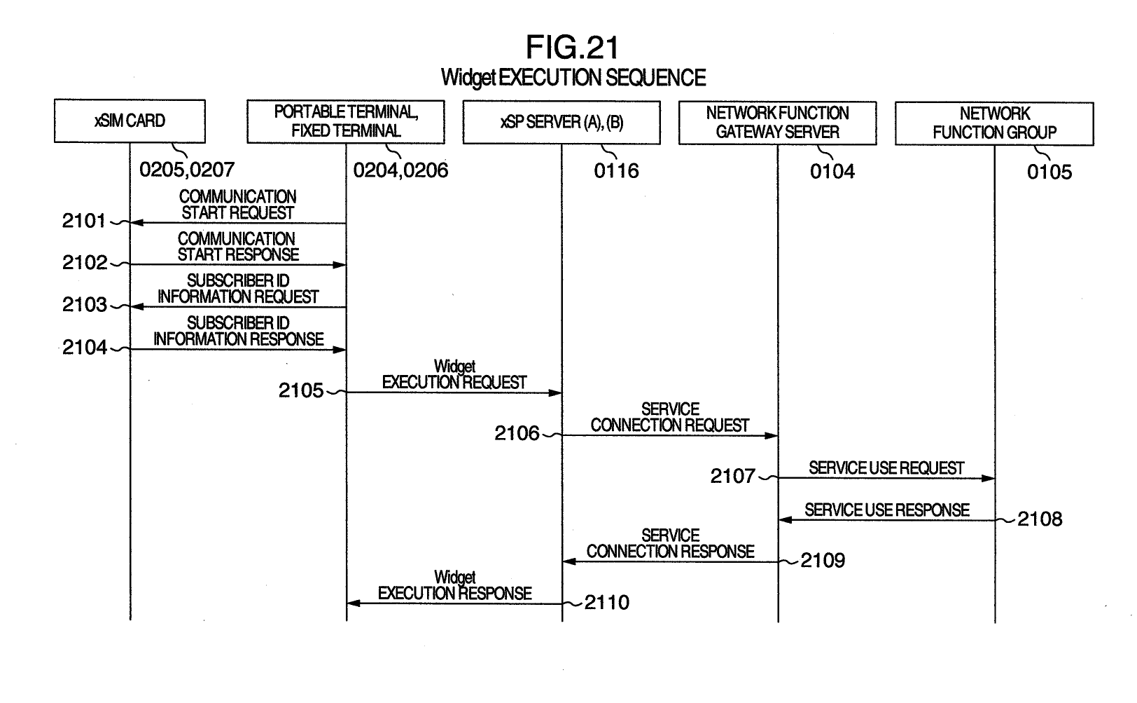

FIG. 21 is a diagram showing the processing sequence for executing the Widget. The portable terminal 0204 or the fixed terminal sends a communication start request to the xSIM card thereof, and the xSIM card sends a communication start response 2102. Then, the portable terminal 0204 or the fixed terminal transmits a subscriber identification information request 2103 to the xSIM card thereof, which in turn transmits a subscriber identification information response 2104. The portable terminal 0204 or the fixed terminal transmits a Widget execution request (display content control request) 2105 to the xSP server (A), (B) 0116, which in turn transmits a service connection request 2106 to the network function gateway server. The network function gateway server transmits a service use request 2107 to the network function group. Immediately after that, the network function group transmits a service use response 2108 to the network function gateway server, which in turn transmits a service connection response 2109 to the xSP server (A), (B) 0116. Then, the xSP server (A), (B) 0116 transmits a Widget execution response (display content control response) 2110 to the portable terminal 0204 or the fixed terminal.

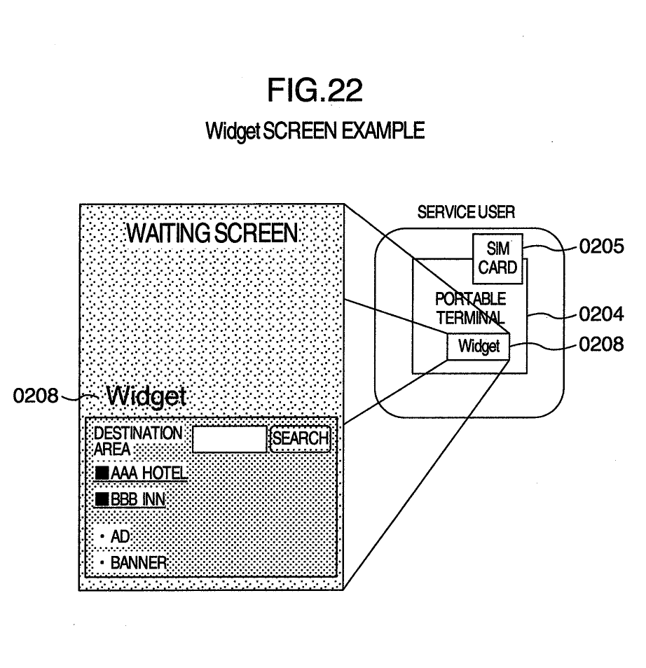

FIG. 22 is a diagram showing an example of the Widget execution screen. This example of the screen is that of the portable terminal 0204 having the xSIM card 0205. The Widget 0208 is developed by a certain travel agent as a service provider based on the Widget program template supplied from the communication common carrier. The destination area column of the Widget 0208 is filled and the search button is clicked. Then, a list of inns and hotels in the destination area with which the travel agent transacts is output. By clicking the link of the output result thereof, the facility clicked can be called by phone. Also, a banner advertisement is buried in the Widget 0208, and the service provider can gain the advertisement fee from the click operation of the general subscriber.

It should be further understood by those skilled in the art that although the foregoing description has been made on embodiments of the invention, the invention is not limited thereto and various changes and modifications may be made without departing from the spirit of the invention and the scope of the appended claims.

1. A communication method using a base server having a plurality of network functions, a service provider sever for communicating with the base server and a subscriber information management data base,
wherein the base server executes the steps of:
receiving a message requesting the use of at least one network function from the service provider server;
retrieving the subscriber information corresponding to the service provider server from the subscriber information management server and authenticating the service provider server as a subscriber;
generating the session information for using the network function based on the authentication; and
transmitting a message permitting the use of the network function to the service provider server based on the session information.

2. The communication method according to claim 1,
wherein the base server further executes the steps of:
transmitting an authentication request message to the service provider server; and
receiving an authentication response message from the service provider server before the authentication step.

3. The communication method according to claim 1,
wherein the base server further executes the step of:
performing the network function permitted to use by the use permit message and transmitting a response message containing the result of performing the network function to the service provider server.

4. The communication method according to claim 1,
wherein the base server manages the number of times the network function is used by the service provider server.

5. The communication method according to claim 1,
wherein the base server manages the number of times the network function is used by the service provider server and executes the process of charging the service providing server in accordance with the number of times the network function is used.

6. The communication method according to claim 1,
wherein the authentication response message received by the base server from the service provider server contains the service subscriber information read by the service provider server from a subscriber information storage unit.

7. The communication method according to claim 6,
wherein the subscriber information storage unit is included in selected one of the service provider server and a terminal communicating with the service provider server.

8. The communication method according to claim 1,
wherein the session information generating step generates the session information containing a transaction identifier, a session key used for encryption of the communication and a session deadline in correspondence with the identifier of the authenticated subscriber, and
wherein the use permit message includes the session information.

9. The communication method according to claim 3,
wherein the authentication step includes the substeps of reading, from the subscriber information management data base, the contract type information indicating whether the subscriber is a prepaid user, a general user or service provider and a service menu identifier information registered in advance for the service provider server, and complementing the session information, and
wherein the network function execution step includes the substeps of judging the usability of the network function based on the contract type information and determining the usability and the charge rule for each network function based on the service menu identifier information.

10. The communication method according to claim 1,
wherein the network function execution step includes the substep of managing selected one of the number of the simultaneously connected service provider servers and the number of the requests received to use the network function per unit time, and in the case where the number of the simultaneously connected service provider servers or the number of the use requests exceeds a predetermined threshold value, not permitting the use of the network function.

11. The communication method according to claim 1,
wherein the network functions are managed independently of the service provider server.

12. The communication method according to claim 1,
wherein the network functions are provided externally through a network for the voice speech function, the SMS-push function and the position information function.

13. A communication system comprising a service provider server, a service user terminal, a service base server, a service subscriber information storage unit and a communication network,
wherein the service subscriber information storage unit stores the subscriber information for the services managed by the service base server,
wherein the service provider server reads the subscriber information from the service subscriber information storage unit and transmits the, subscriber information to the service base server, and
wherein the service base server includes an authentication processing unit for processing the authentication of the subscriber based on the subscriber information, and a function control unit for controlling at least one of the plurality of service functions based on the result of authentication by the authentication processing unit and transmitting the result of processing the service function to the service provider server.

14. A method of accessing a service provider base for permitting a third-party service provider server to use the service function of another server through a fixed communication network or an internet, comprising the steps of:
a service provider base server distributing an application containing a command for transmitting a service function use request message to the user of the service of the service provider server;
the service provider server receiving and retransmitting the transmitted service function use request message by the operation of the application;
the service provider base server receiving the service function use request message from the service provider server;
the service provider base server transmitting a subscriber authentication request message to the service provider server;
the service provider base server receiving a subscriber authentication response message from the service provider server;
the service provider base server authenticating the service provider server as a subscriber by accessing the subscriber information for the service provider server in the subscriber information management data base and generating the session information to use the service function;
the service provider base server transmitting a message permitting the use of the service function to the service provider server;
the service provider base server executing at least one service function based on the service function use request received from the service provider server;
the service provider base server transmitting a response message containing the result of execution of the service function to the service provider server; and
the service provider base server recording the number of times the service function is used, and generating the charge information based on the number of times the service function is used.

15. The service provider base access method according to claim 14, further comprising the steps of:
the service provider base server reading the subscriber information from the service subscriber information storage unit to store the subscriber information for the services managed by the service provider base server, and
the service provider base server authenticating the terminal using the services of the service provider server, in accordance with the subscriber information,
wherein the service function use request message received from the application contains the session information of the terminal, and
wherein the service function execution step includes the substep of specifying the subscriber identifier based on the session information, and executing the service function with the subscriber identifier as a parameter for service execution.
